(19) United States
(12) Patent Application Publication
(10) Pub. No.: US 2026/0254549 A1
(43) Pub. Date: Aug. 27, 2026

(54) METHOD AND APPARATUS FOR ENHANCING PRECISION TIME PROTOCOL TIMESTAMP PRECISION USING MACHINE LEARNING CIRCUIT WITH AID OF FEATURE-AND-MODEL PRE-SELECTION AND PARAMETER PRE-TUNING

(71) Applicant: Realtek Semiconductor Corp., HsinChu (TW)

(72) Inventors: Wei-Kuo Mai, HsinChu (TW); He-Ping Li, HsinChu (TW)

(73) Assignee: Realtek Semiconductor Corp., HsinChu (TW)

(21) Appl. No.: 19/426,072

(22) Filed: Dec. 19, 2025

(30) Foreign Application Priority Data
Feb. 27, 2025 (TW) 114107259

(51) Int. Cl. H04J 3/06; G06N 20/00; H04L 43/0852

(52) U.S. Cl. CPC H04J 3/0667; G06N 20/00; H04L 43/0852

(57) ABSTRACT

A method and apparatus for enhancing precision time protocol (PTP) timestamp precision using a machine learning (ML) circuit with aid of feature-and-model pre-selection (FMPS) and parameter pre-tuning (PPT) are provided. The apparatus includes a communication circuit, for performing communication operations for an electronic device, and the ML circuit, for performing time calculation for the communication circuit. The communication circuit includes a PTP timestamp generation circuit, for generating at least one timestamp in at least one packet; and the ML circuit includes a pre-selected model running on the ML circuit, the pre-selected model arranged to obtain a set of pre-selected features from the communication circuit, and convert the set of pre-selected features into at least one time calculation result according to a set of pre-tuned parameters, to allow the PTP timestamp generation circuit to generate the at least one timestamp according to the at least one time calculation result.

### BACKGROUND OF THE INVENTION

### 1. Field of the Invention

The present invention is related to clock synchronization, and more particularly, to a method and apparatus for enhancing precision time protocol (PTP) timestamp precision using a machine learning (ML) circuit with aid of feature-and-model pre-selection (FMPS) and parameter pre-tuning (PPT).

### 2. Description of the Prior Art

According to the related art, PTP-compliant products may communicate with each other for the purpose of clock synchronization. For example, in a PTP-compliant system, there may be various types of clocks (or clock types) such as grandmaster clock (GMC), ordinary clock (OC), boundary clock (BC), and transparent clock (TC). The GMC may obtain accurate time from a time source and may be deployed in a high-cost electronic device, while the other clocks may calibrate their respective times based on the accurate time from the GMC, and may be implemented in multiple low-cost electronic devices. However, the respective clocks of these low-cost electronic devices may fail to achieve ideal time synchronization results. In an attempt to enhance the respective clock synchronization performance of these low-cost electronic devices, additional problems (or side effects) such as increased circuit complexity, additional storage requirements, degraded transmission performance, etc. may be introduced. To date, it seems that there is no perfect solution in the related art. Accordingly, there is a need for a novel method and associated architecture to solve the problems without introducing side effects, or in a way that is less likely to introduce a side effect.

### SUMMARY OF THE INVENTION

An objective of the present invention is to provide a method and apparatus for enhancing PTP timestamp precision using an ML circuit with the aid of FMPS and PPT, in order to solve the problems in the related art.

At least one embodiment of the present invention provides an apparatus for enhancing PTP timestamp precision using an ML circuit with the aid of FMPS and PPT. The apparatus comprises a communication circuit configured to perform communication operations for an electronic device, and the ML circuit coupled to the communication circuit, configured to perform time calculation for the communication circuit. The communication circuit comprises a PTP timestamp generation circuit positioned on a transmission path of the communication circuit, configured to generate at least one timestamp in at least one packet so as to enable the communication circuit to transmit the at least one packet carrying the at least one timestamp. The ML circuit comprises a pre-selected (or preselected) model running thereon, configured to obtain a set of pre-selected features from the communication circuit, and convert the set of pre-selected features into at least one time calculation result according to a set of pre-tuned parameters, thereby allowing the PTP timestamp generation circuit to generate the at least one timestamp according to the at least one time calculation result.

At least one embodiment of the present invention provides a method for enhancing PTP timestamp precision using an ML circuit with the aid of FMPS and PPT. The method may comprise: utilizing a communication circuit to perform communication operations for an electronic device, where the communication circuit comprises a PTP timestamp generation circuit positioned on a transmission path of the communication circuit; and utilizing the ML circuit to perform time calculation for the communication circuit, where the ML circuit comprises a pre-selected model running on the ML circuit. For example, utilizing the communication circuit to perform the communication operations for the electronic device may further comprise: utilizing the PTP timestamp generation circuit to generate at least one timestamp in at least one packet to allow the communication circuit to transmit the at least one packet carrying the at least one timestamp. In addition, utilizing the ML circuit to perform the time calculation for the communication circuit may further comprise: utilizing the pre-selected model running on the ML circuit to obtain a set of pre-selected features from the communication circuit, and convert the set of pre-selected features into at least one time calculation result according to a set of pre-tuned parameters, thereby allowing the PTP timestamp generation circuit to generate the at least one timestamp according to the at least one time calculation result.

One of the advantages of the present invention is that the proposed method and the associated apparatus in the present invention are capable of enhancing clock synchronization performance to achieve an ideal synchronization result, thereby enhancing the overall performance of the electronic device. Moreover, the proposed method and the associated apparatus in the present invention are capable of solving the problems in the related art without introducing side effects, or in a way that is less likely to introduce a side effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an apparatus for enhancing PTP timestamp precision using an ML circuit with the aid of FMPS and PPT according to an embodiment of the present invention, where the apparatus operates in accordance with a method for enhancing PTP timestamp precision using an ML circuit with the aid of FMPS and PPT.

FIG. 2 illustrates a fixed latency control scheme.

FIG. 3 illustrates an ML-based control scheme of the method according to an embodiment of the present invention.

FIG. 4 illustrates a simulation-based control scheme of the method according to an embodiment of the present invention.

FIG. 5 illustrates a working flow of the parameter tuning shown in FIG. 4 according to an embodiment of the present invention.

FIG. 6A illustrates some implementation details of the simulation-based control scheme shown in FIG. 4, according to an embodiment of the present invention.

FIG. 6B illustrates some other implementation details of the simulation-based control scheme shown in FIG. 4, according to an embodiment of the present invention.

FIG. 7 illustrates a working flow of the method according to an embodiment of the present invention.

### DETAILED DESCRIPTION

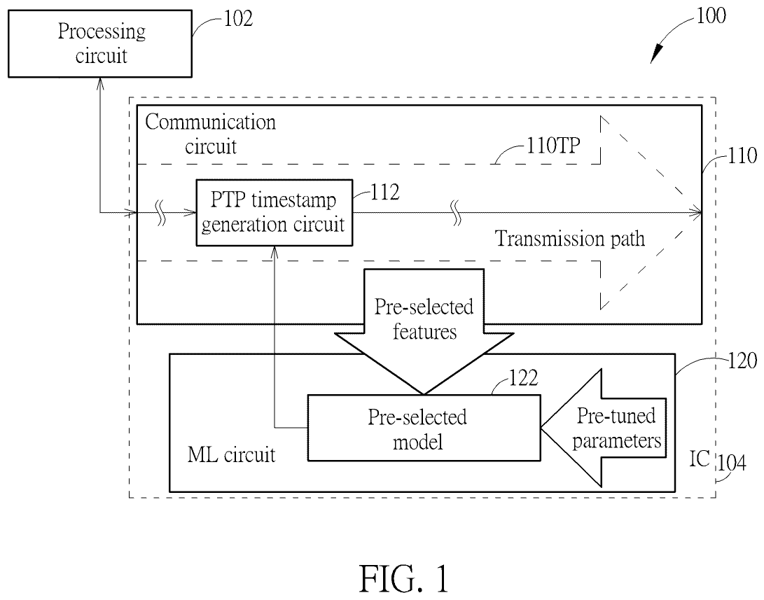

FIG. 1 is a schematic diagram of an apparatus 100 for enhancing PTP timestamp precision using an ML circuit (e.g., the ML circuit 120) with the aid of FMPS and PPT according to an embodiment of the present invention, where the apparatus 100 operates in accordance with a method for enhancing PTP timestamp precision using an ML circuit with the aid of FMPS and PPT. The apparatus 100 comprises a communication circuit 110 configured to perform communication operations for an electronic device, and the ML circuit 120 coupled to the communication circuit 110 and configured to perform time calculation for the communication circuit 110, where the communication circuit 110 and the ML circuit 120 may be integrated into an integrated circuit (IC) 104 such as a communication IC, and the apparatus 100 may comprise the IC 104, but the invention is not limited thereto. According to some embodiments, the apparatus 100 may comprise the whole of the electronic device and/or represent the electronic device. In particular, the apparatus 100 may comprise a processing circuit 102 configured to control operations of the electronic device, and the IC 104 configured to perform communication operations as well as PTP-related operations for achieving PTP clock synchronization. The electronic device may be implemented as any electronic device having a communication function and a PTP clock synchronization function (or a function of performing clock synchronization according to PTP), and preferably further having at least one additional function such as sensing, actuation, etc. Examples of the electronic devices include but are not limited to: various Internet of things (IoT) devices within IoT systems such as transportation, industrial, manufacturing, healthcare, and home automation IoT systems.

As shown in FIG. 1, the communication circuit 110 comprises a PTP timestamp generation circuit 112, positioned on a transmission path 110TP of the communication circuit 110, configured to generate at least one timestamp in at least one packet, thereby allowing the communication circuit 110 to transmit the aforementioned at least one packet carrying the aforementioned at least one timestamp, such as multiple packets, each carrying a respective timestamp thereof. The ML circuit 120 comprises a pre-selected model 122 running on the ML circuit 120, configured to obtain a set of pre-selected features from the communication circuit 110, and convert the set of pre-selected features into at least one time calculation result according to a set of pre-tuned parameters, thereby allowing the PTP timestamp generation circuit 112 to generate the aforementioned at least one timestamp according to the aforementioned at least one time calculation result. The communication circuit 110 and the ML circuit 120 are installed in the electronic device to allow or enable the electronic device to perform time synchronization in accordance with the PTP.

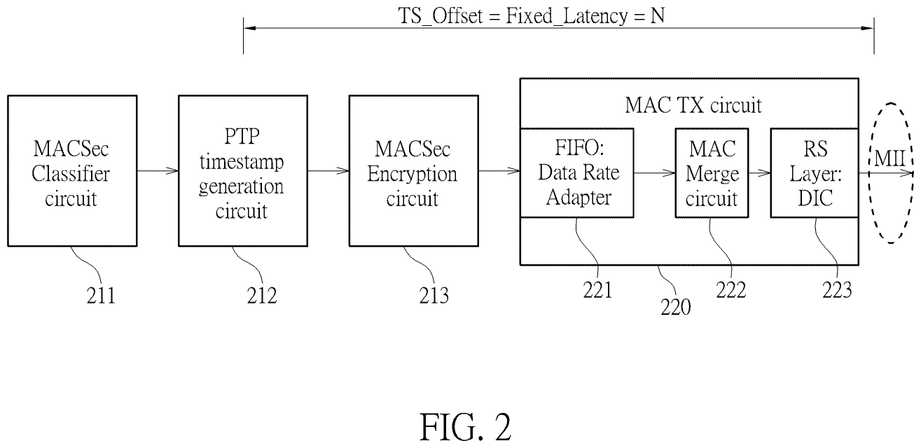

For better comprehension, FIG. 2 illustrates a fixed latency control scheme. Assume that some functions of the electronic device may be temporarily disabled to allow the electronic device to operate according to the fixed latency control scheme, but the invention is not limited thereto. The electronic device may comprise multiple medium access control (MAC) layer sub-circuits positioned on a transmission path, such as a MAC security classifier (or “MACSec Classifier”) circuit 211, a PTP timestamp generation circuit 212, a MAC security encryption (or “MACSec Encryption”) circuit 213, and a MAC transmission (TX) circuit 220, and the MAC TX circuit 220 may comprise a First-In-First-Out (FIFO) memory 221 (labeled “FIFO” for brevity) serving as a data rate adapter, a MAC Merge circuit 222, and a Reconciliation Sub layer (RS layer) circuit 223 (labeled “RS Layer” for brevity) configured to maintain a Deficit Idle Count (DIC) within a predetermined range, connected toward a Media Independent Interface (MII). The fixed latency control scheme may be used for controlling a timestamp offset TS_Offset as a fixed latency, such as N time units (denoted as “TS_Offset=Fixed_Latency=N” for brevity), for example, by adding FIFOs at both input and output ends and adding a latency monitor, or by specially designing the circuits to inherently have fixed latency. Although adopting the fixed latency control scheme may make the calculation of timestamps become easy, there are many disadvantages such as: the requirement for the circuit to exhibit strictly fixed latency, increased overall circuit latency, reduced throughput, and potential conflicts between the fixed latency design and parts of the IEEE 802.3 standard (e.g., the IEEE 802.3br MAC Merge sublayer). When the fixed latency control scheme is replaced with a prediction control scheme, a delay predictor may be used for referring to the respective accurate exit time of some previously transmitted packets leaving from the system and the lengths of all packets present in the system to predict the time that a packet resides at the MAC TX circuit to be the time of the timestamp, where dummy packets may be added or inserted to enhance prediction accuracy. However, the prediction control scheme also has some disadvantages, such as: the need for a dedicated memory (e.g., FIFO or static random-access memory (SRAM)) to record the sending out time of each packet leaving from the system, the need for addition/subtraction circuits to continuously calculate the differences between the actual sending out time and the predicted sending out time to calibrate the predicted timestamp, the use of dummy packets, indirectly resulting in bandwidth loss, etc.

TABLE 1

| | | | Proposed |
|---|---|---|---|
| | Fixed latency | Prediction | method in |
| | control | control | present |
| | scheme | scheme | invention |
| Core | Use FIFOs | Use delay | Establish |
| technology | and add | predictor | model and |
| | latency | to predict | trained |
| | monitor | | parameters |
| Calculation | Not | Addition (ADD), | e.g., Multiply |
| | Applicable (N/A) | subtraction | Accumulate |
| | | (SUB), etc. | |
| Circuit | Low | Medium | Medium |
| complexity | | | |

Table 1 compares the proposed method with the aforementioned prediction and fixed latency control schemes. The fixed latency control scheme conflicts with existing standards, while the prediction control scheme consumes a large amount of SRAM memory resources. In contrast, the proposed method can simplify a large amount of data into mathematical formulas through ML training in advance for efficiently calculating the results, to eliminate the need for complex and costly circuit implementations while maintaining flexibility for real-time timestamp prediction. For example, when using a linear regression model, the communication circuit 110 can generate accurate timestamps with the aid of Multiply Accumulate calculations performed by the ML circuit 120, for enhancing the overall performance.

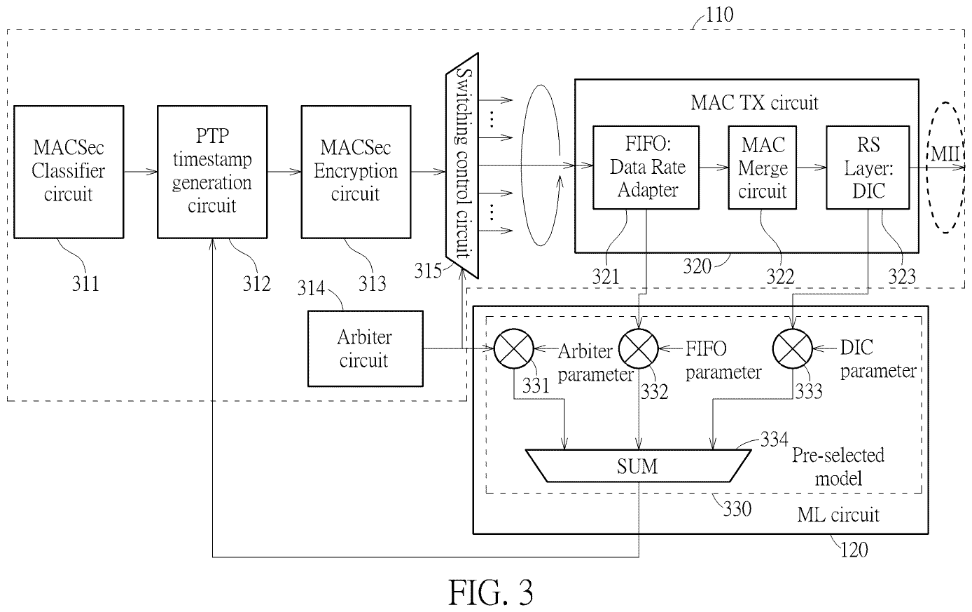

FIG. 3 illustrates an ML-based control scheme of the method according to an embodiment of the present invention. The communication circuit 110 comprises multiple sub-circuits positioned on the transmission path 110TP, and the PTP timestamp generation circuit 112 such as the PTP timestamp generation circuit 312 is one of the multiple sub-circuits. The multiple sub-circuits comprise multiple MAC layer sub-circuits, which may comprise a MAC security classifier (or “MACSec Classifier”) circuit 311, a PTP timestamp generation circuit 312, a MAC security encryption (or “MACSec Encryption”) circuit 313, an arbiter circuit 314, a switching control circuit 315, and at least one MAC TX circuit 320 such as multiple MAC TX circuits 320 respectively corresponding to multiple channels, and under the control of the arbiter circuit 314, the multiple MAC TX circuits 320 may take turns receiving packets from the switching control circuit 315 and perform subsequent processing on the packets for completing sending out the packets, where any MAC TX circuit 320 among the multiple MAC TX circuits 320 may comprise a FIFO memory 321 (labeled “FIFO” for brevity) serving as a data rate adapter, a MAC Merge circuit 322, and an RS layer circuit 323 (labeled “RS Layer” for brevity) configured to maintains a DIC within a predetermined range (e.g., the range of the interval [0, 3]), connected toward an MII. The above-mentioned pre-selected model 122 running on the ML circuit 120, such as the pre-selected model 330, may comprise multiple multiplier circuits 331, 332, and 333, and an accumulator circuit, such as a summation circuit 334 (labeled “SUM” for brevity), for performing the aforementioned Multiply Accumulate calculations. The set of pre-selected features may comprise arbiter-related features obtained from the arbiter circuit 314, FIFO-related features obtained from the FIFO memory 321, and RS-layer-related features obtained from the RS layer circuit 323, respectively input into the multiplier circuits 331, 332, and 333, and the set of pre-tuned parameters may comprise an arbiter parameter, a FIFO parameter, and a DIC parameter, respectively input into the multiplier circuits 331, 332, and 333. The multiplier circuits 331, 332, and 333 perform multiplication operations and output their corresponding multiplication results to the summation circuit 334, respectively. As a result, the summation circuit 334 adds the multiplication results to generate a summation result as the time calculation result, for being output to the PTP timestamp generation circuit 312. In some embodiments, the aforementioned FMPS and PPT may vary, and the architecture shown in FIG. 3 may vary correspondingly.

Under the control of the ML circuit 120, the time indicated by the aforementioned at least one timestamp and the time at which the aforementioned at least one packet is sent out from the electronic device correspond to or align with each other, without being affected by any varying latency of the communication circuit 110. For example, among the multiple sub-circuits positioned on the transmission path 110TP, some sub-circuits may exhibit fixed latency, while others may exhibit varying latency, thereby causing the overall latency experienced by the packets along the transmission path 110TP to vary over time. The communication circuit 110 may utilize the ML circuit 120 to perform time calculation (e.g., the Multiply Accumulate calculations) in order to generate the aforementioned at least one time calculation result, for generating the correct/accurate timestamp. In particular, the aforementioned at least one time calculation result may indicate the latency of the time (or the time point) at which the aforementioned at least one packet is sent out from the electronic device with respect to the time (or the time point) at which the aforementioned at least one timestamp is generated in the aforementioned at least one packet. For example, assuming that the aforementioned at least one time calculation result represents a calculated latency, the PTP timestamp generation circuit 312 may add this latency to the current time such as the time at which the aforementioned at least one timestamp is generated into the aforementioned at least one packet (or the time at which the timestamp is stamped) to generate a timestamp value for being recorded into the aforementioned at least one packet as the timestamp (or the time recorded thereby), which can be the correct timestamp without be affected by any varying latency of the communication circuit 110. In another example, assuming that the aforementioned at least one time calculation result represents the calculated time, the ML circuit 120 may input the current time into the summation circuit 334 to make the summation circuit 334 add the current time and the calculated latency to generate the calculated time, for being output to the PTP timestamp generation circuit 312, and the PTP timestamp generation circuit 312 may record the calculated time obtained from the ML circuit 120 into the aforementioned at least one packet as the timestamp (or the time recorded thereby), which can be the correct timestamp without be affected by any varying latency of the communication circuit 110.

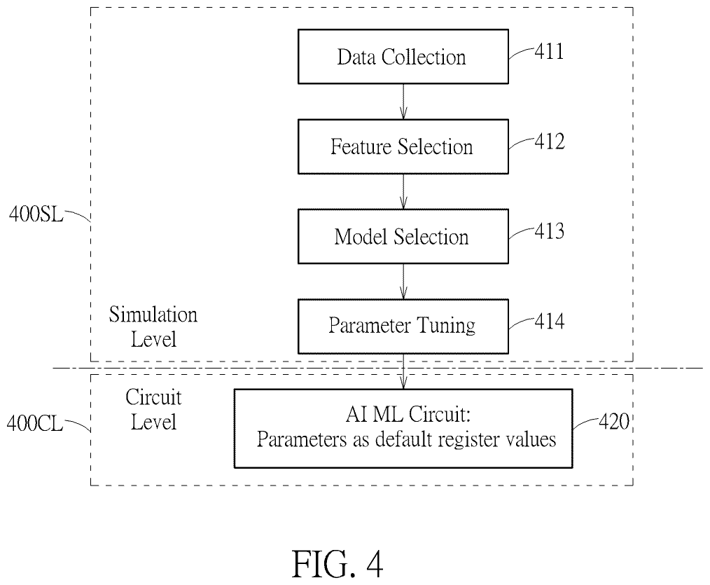

FIG. 4 illustrates a simulation-based control scheme of the method according to an embodiment of the present invention. The set of pre-selected features, the pre-selected model 122 such as the pre-selected model 330, and the set of pre-tuned parameters are obtained in at least one previous level/phase before a manufacturing level/phase of the IC 104. The manufacturing level/phase may represent at least one level/phase for manufacturing the ML circuit 120, collectively referred to as the circuit level/phase 400CL (labeled “Circuit Level” for brevity), while the aforementioned at least one previous level/phase may comprise at least one simulation level/phase (e.g., one or more simulation level/phases), collectively referred to as the simulation level/phase 400SL (labeled “Simulation Level” for brevity). A procedure for obtaining the set of pre-selected features, the pre-selected model 122 such as the pre-selected model 330, and the set of pre-tuned parameters may comprise:
(1) Data Collection 411: Perform data collection regarding multiple predetermined features of the communication circuit 110, such as the respective circuit features of at least one portion of sub-circuits among the multiple sub-circuits on the transmission path 110TP, to establish a database of multiple predetermined models, for determining the set of pre-selected features, for example, during the simulation level/phase 400SL, use a large amount of regression data to establish the database of the multiple predetermined models, and more particularly, obtain a large amount of data from dependent variable (DV) regression simulation, remove outliers, and normalize data (e.g., by using pause frame patterns);
(2) Feature Selection 412: Select a set of predetermined features among the multiple predetermined features such as the aforementioned circuit features to be the set of pre-selected features, for example, after algorithm analysis, rank the aforementioned circuit features by importance to select one or more most important features as the set of pre-selected features, and more particularly, analyze circuit behaviors to select the one or more most important features;
(3) Model Selection 413: Select a predetermined model among the multiple predetermined models to be the pre-selected model 122 such as the pre-selected model 330, for example, considering both the cost and the accuracy, preferentially select a more competitive model/architecture as the pre-selected model 122 from the multiple predetermined models, and more particularly, from the multiple predetermined models such as Linear Regression, Decision Tree Regression, Vector Regression, Support Vector Regression (SVR), Neural Networks, etc., preferentially select the Linear Regression model with lower hardware cost as the pre-selected model 122;
(4) Parameter Tuning 414: Perform parameter tuning on the predetermined model (or the pre-selected model 122 such as the pre-selected model 330) to obtain multiple tuned parameters of the predetermined model, such as the optimal parameters obtained from calculations over a large among of data, to be the set of pre-tuned parameters, for example, the parameter tuning 414 may comprise parameter optimization, in particular, during optimizing the model parameters, use regression analysis first to calculate the parameters, and continuously perform ML to check for data drift, and dynamically adjust parameters; and
(5) Artificial Intelligence (AI) ML Circuit Implementation 420 (labeled “AI ML Circuit” for brevity): Design the set of pre-tuned parameters as the respective default values (or “default register values”) of the registers (such as the parameter registers) corresponding to the set of pre-selected features, where the AI ML circuit such as ML circuit 120 may store and/or load the set of pre-tuned parameters such as these default register values, for use in the above-mentioned time calculation;
where the optimal model and parameters are obtained during the simulation level/phase 400SL, for implementing the ML circuit 120 in the circuit level/phase 400CL. Taking the architecture shown in FIG. 3 as an example of the circuit design thereof, assuming that the operation of the feature selection 412 obtains/selects three features corresponding to three parameters, such as the three features respectively from the arbiter circuit 314, the FIFO memory 321, and the RS layer circuit 323, and that during simulation, the operation of the parameter tuning 414 obtains their corresponding parameters (e.g., the optimal parameters), these parameters may be used as the initial values for the parameter registers.

The circuit design of the ML circuit 120 depends on the selected model type. For example, when adopting the Linear Regression model, the communication circuit 110 can generate the correct/accurate timestamp (or the time value recorded thereby) with the aid of the Multiply Accumulate calculations performed by the ML circuit 120, but the present invention is not limited thereto. Assuming that cost constraints are disregarded to achieve higher numerical precision, the model and the associated implementation may be replaced by the model of a recurrent neural network (RNN) algorithm (or the model of any other deep learning algorithm) and the corresponding hardware implementation, respectively. Additionally, whenever it is needed to stamp a timestamp, the PTP timestamp generation circuit 312 may generate the timestamp based on the time calculation result currently calculated by the ML circuit 120, and more particularly, put the calculated time into the packet (e.g., a PTP packet).

Some implementation details of the simulation-based control scheme may be further described as follows. Regarding the feature selection 412, the methods for obtaining the important features may comprise: Statistical Methods, which can be used for calculating the correlation between the features and the target variable, to remove less relevant features, for example, the Pearson correlation coefficient may be used for measuring the strength of a linear relationship between two variables; Filter Methods, which can be used for evaluating the importance of the features based on the independent correlation of the features with the target variables, where the common filter methods comprise Chi-square Test, Mutual Information (MI), etc.; Wrapper Methods, for example, the Recursive Feature Elimination (RFE) method, which can be used for iteratively removing less important features based on the importance derived from a given model, and other methods such as Forward Selection, Backward Elimination, etc.; Embedded Methods, which can be used for learning the weights of the features through model training and evaluating the importance of the features based on the weights, where the common embedded methods comprise LASSO regression, Decision Tree, etc.; and Automated Feature Selection, for example, involved with using various tools such as AutoML, SelectKBest, RFE, SelectFromModel, etc. to automatically select features.

TABLE 2

| Features | Contents/Examples |
|---|---|
| Packet Length | Sizes of current and several previous packets |
| MAC Speed | 10M, 100M, 1G, 10G |
| Bus Width | 8-bit, 64-bit |
| FIFO Status | Full, Almost Full, Empty |
| TDM Arbiter | Selection Status |
| DIC | Counter Status |
| Flow Control | Pause Frame, Half Duplex |

Table 2 illustrates examples of the multiple predetermined features (or the aforementioned circuit features), where examples of the packet length may comprise the sizes of the current and several previous packets, examples of the MAC speed may comprise 10 megabits per second (Mbps), 100 Mbps, 1 gigabit per second (Gbps), and 10 Gbps (labeled {10M, 100M, 1G, 10G} for brevity), examples of the bus width may comprise 8 bits and 64 bits, examples of the FIFO status may comprise Full, Almost Full, and Empty, examples of the time division multiplexing (TDM) arbiter may comprise Selection Status, examples of the DIC may comprise Counter Status, examples of the flow control may comprise Pause Frame and Half Duplex, but the present invention is not limited thereto. According to some embodiments, the types of the multiple predetermined features and/or the contents/examples of the multiple predetermined features may vary.

Regarding the model selection 413, the multiple predetermined models may comprise: Linear Regression/Polynomial Regression models, which are suitable for regression problems (for predicting continuous values) under the assumption of the existence of a linear relationship between the features and the target variable, and have advantages such as simplicity, fast computation speed, and ease of interpretation (or understanding); Decision Tree models, which have a simple structure and thus possess certain advantages in handling nonlinear data, where due to their lower computational resource requirements, the decision tree models are suitable for hardware implementations with limited resources, but they may be prone to overfitting; Vector Regression models (or variant such as SVR), which are applicable to regression problems, especially nonlinear relationships, and can handle high-dimensional data, and have advantages such as being less sensitive to outliers and capable of capturing complex nonlinear relationships; and Neural Network models, which can be applied to various complex problems comprising classification, regression, image recognition, etc., require large amounts of data to fully realize their potential, and have advantages such as being capable of capturing highly complex nonlinear relationships, strong adaptability, etc., but have disadvantages such as high computational resource demands, poor model interpretability, etc. Taking the Linear Regression model as an example, the pre-selection model 122 running on the ML circuit 120 may be designed according to the following equation:

$$y = {β}_{0} + \sum ( {β}_{i} * {x}_{i} ) + ε ;$$

where xᵢ may represent the input feature, βᵢ may represent the model parameter (or weight), β₀ may represent a constant term (or bias), and ε may represent the error term (or value). After training, if the product (βᵢ*xᵢ) corresponding to a certain feature xᵢ is larger, it indicates that this feature xᵢ is more important.

TABLE 3

| Input/Output and Parameter | Contents/Examples |
|---|---|
| Inputs {xᵢ} | 1500 bytes, Token = 001, Empty/Full |
| Parameters {βᵢ} | Packet length, TDM Arbiter, FIFO status |
| Output y | Time Calculation Result |

Table 3 illustrates examples of the multiple inputs {xᵢ}, the multiple parameters {βᵢ}, and the output y of the aforementioned Multiply Accumulate calculations, where examples of the multiple inputs {xᵢ} may comprise 1500 bytes, Token=001, Empty/Full status, etc., examples of the multiple parameters {βᵢ} may comprise the packet length, the TDM Arbiter, and the FIFO status, and examples of the output y may comprise the time calculation result, but the present invention is not limited thereto. According to some embodiments, the multiple inputs {xᵢ} and/or the multiple parameters {βᵢ} may vary.

TABLE 4

| | | Operation | | |
|---|---|---|---|---|
| Method | Goal | way | Advantage | Disadvantage |
| Linear | Directly adjust model | Compute | Simple and | Prone to |
| Feedback | parameters | gradients | efficient | converging to |
| | | | | local optimal |
| | | | | solution |
| Least Squares | Find a set of parameters | Iterative | Robust and | Prone to being |
| | that minimize squared | algorithm | easy to | overfitting |
| | difference between | | understand | |
| | predicted values and | | | |
| | actual values | | | |
| Normalization/ | Find a set of parameters | Add penalty | Capable of | Increased |
| Regularization | that minimize squared | term to loss | preventing | computational |
| | difference between | function | overfitting | complexity |
| | predicted values and | | | |
| | actual values while | | | |
| | minimizing sum of | | | |
| | squares or absolute | | | |
| | values of model | | | |
| | parameters | | | |
| Bayesian | Infer probability | Bayesian | Capable of | Large amount |
| Method | distribution of | theorem | obtaining | of calculation |
| | parameters from data | | uncertainty | |
| | | | of parameters | |

Regarding the parameter tuning 414, Table 4 illustrates examples of the methods used for tuning/optimizing parameters, comprising: Linear Feedback, which aims to directly adjust the model parameters to minimize the difference between the predicted values and the actual values of the model; Least Squares, which aims to find a set of parameters that minimize the squared difference between the predicted values and the actual values, for example, find the Least Square Error (LSE); Normalization/Regularization, which aims to find a set of parameters that minimize the squared difference between the predicted values and the actual values while also minimizing the sum of squares or absolute values of the model parameters; and Bayesian Method, which aims to infer the probability distribution of the parameters from the data. Overfitting refers to the phenomenon where a model fits a specific dataset too closely or precisely, thereby failing to generalize well to other data or to predict future observations accurately.

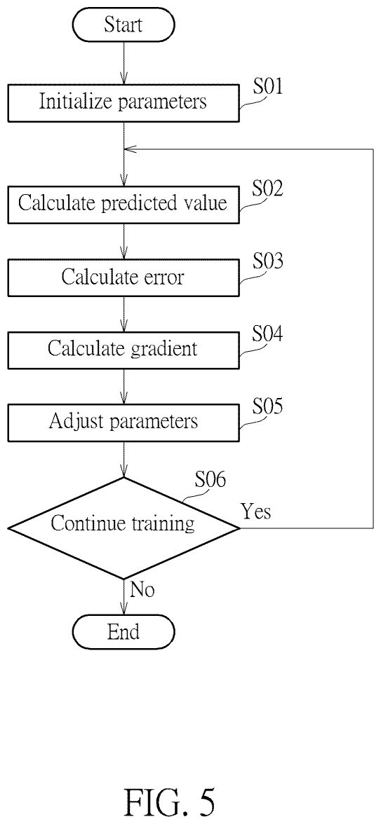

Taking using the Linear Feedback method to automatically adjust the parameters as an example, functions may be employed for calculating the model's predicted value, the error, and the gradient, and adjust the parameters of the model (or “the model parameters”) accordingly. FIG. 5 illustrates a working flow of the parameter tuning 414 shown in FIG. 4 according to an embodiment of the present invention. The parameter tuning 414 may comprise Steps S01 to S06:
(S01) Initialize parameters: The initial values may be random or set according to prior knowledge;
(S02) Calculate predicted value: Based on the structure and the parameters of the model, calculate the model's predicted value (or “the model predicted value”) for the current input;
(S03) Calculate error: Calculate the difference between the model's predicted value and the actual value;
(S04) Calculate gradient: Determine the gradient of the model predicted value with respect to the parameters, where the gradient indicates the direction and the magnitude of change of the model predicted value in the parameter space;
(S05) Adjust parameters: Adjust the model parameters along the gradient direction, where the adjustment magnitude may be controlled by a learning rate; and
(S06) Determine whether to continue training: Selectively continue training based on whether at least one condition is met, and more particularly, repeat Steps S02 to S05 until the model converges or a preset number of training iterations is reached;
but the present invention is not limited thereto. According to some embodiments, Linear Regression functions may be designed using Excel regression analysis calculations or using Python.

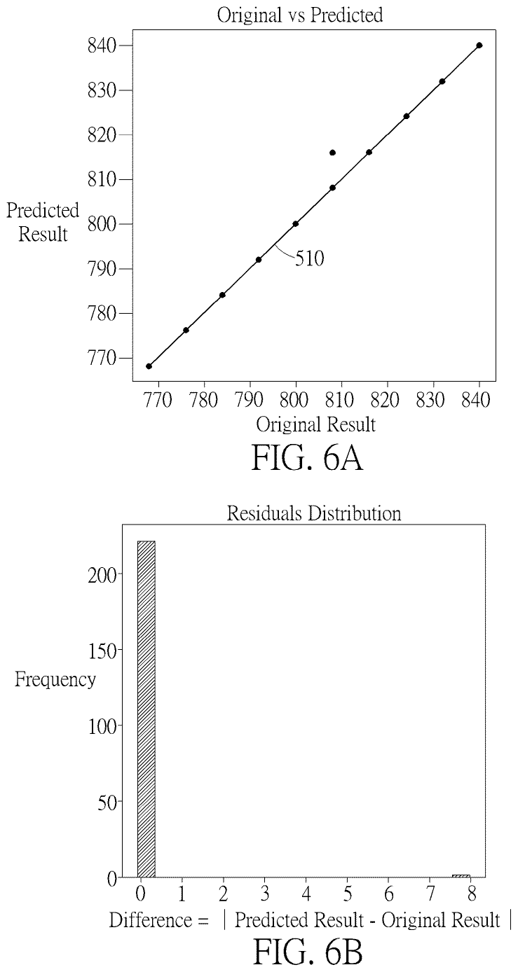

FIG. 6A and FIG. 6B respectively illustrate some implementation details and some other implementation details of the simulation-based control scheme shown in FIG. 4 according to some embodiments of the present invention. Approximately over 200 PTP packets are used during the simulation level/phase 400SL for training, through which corresponding features and parameters are obtained, and the coefficient of determination “R²” from statistics is used for evaluating the difference between the results calculated by the ML and the actual PTP timestamps. The results under two test conditions may comprise: an R² value of 1.0 for non-wirespeed/non-wire-speed conditions; and an R² value of 0.999 for wirespeed/wire-speed conditions. Experimental results demonstrate that by using the ML PTP approach, even with a small amount of training data, highly accurate results can be obtained as shown in FIG. 6A and FIG. 6B. For example, in FIG. 6A, most data points lie on the line 510, where an R² value closer to 1 indicates a higher degree of fit between the model and the data.

According to some embodiments, some operations of the simulation-based control scheme may be selectively performed. For example, when adopting a new circuit architecture, it is necessary to select circuit features during the simulation level/phase 400SL, train related parameters, and select an appropriate model. In another example, if the circuit architecture remains unchanged, the related operations/steps in the simulation level/phase 400SL, such as the data collection 411, the feature selection 412, the model selection 413, and the parameter tuning 414, may be skipped, while using the existing parameters that have been adjusted and the existing model that has been selected.

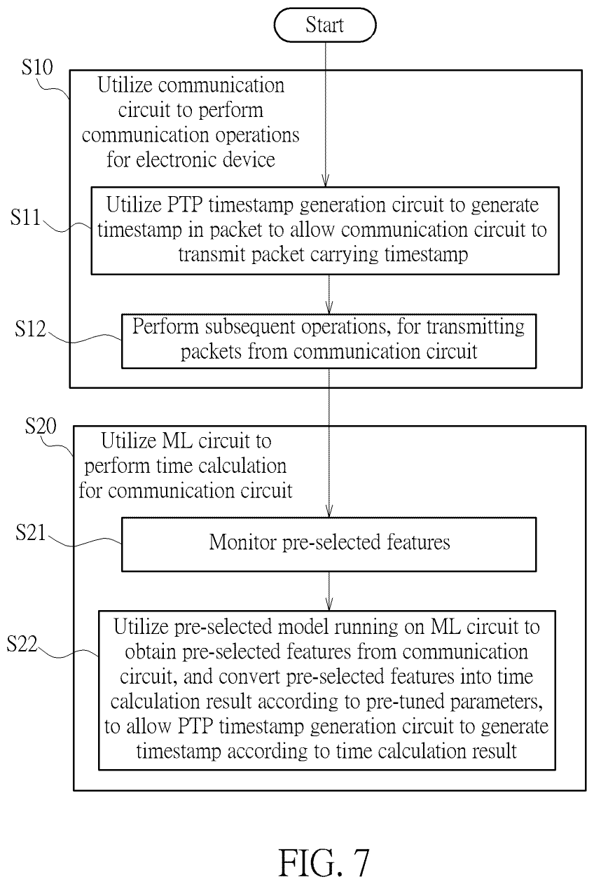

FIG. 7 illustrates a working flow of the method according to an embodiment of the present invention. The apparatus 100 may operate according to the working flow shown in FIG. 7.

In Step S10, the apparatus 100 may utilize the communication circuit 110 to perform communication operations for the electronic device. Step S10 may comprise sub-steps such as Steps S11 and S12.

In Step S11, the apparatus 100 may utilize the PTP timestamp generation circuit 112 to generate the aforementioned at least one timestamp in the aforementioned at least one packet to allow the communication circuit 110 to transmit the aforementioned at least one packet carrying the aforementioned at least one timestamp.

In Step S12, the apparatus 100 may utilize the communication circuit 110 to perform subsequent operations, for transmitting packets from the communication circuit 110.

In Step S20, the apparatus 100 may utilize the ML circuit 120 to perform time calculations for the communication circuit 110. Step S20 may comprise sub-steps such as Steps S21 and S22.

In Step S21, the apparatus 100 may utilize the communication circuit 110 to monitor the set of pre-selected features.

In Step S22, the apparatus 100 may utilize the pre-selected model 122 running on the ML circuit 120 to obtain the set of pre-selected features from the communication circuit 110, and convert the set of pre-selected features into the aforementioned at least one time calculation result according to the set of pre-tuned parameters, to allow the PTP timestamp generation circuit 112 to generate the aforementioned at least one timestamp according to the aforementioned at least one time calculation result.

Regarding any timestamp among the aforementioned at least one timestamp, the apparatus 100 may utilize the pre-selected model 122 running on the ML circuit 120 to obtain the set of pre-selected features (or the latest values thereof) from the communication circuit 110, and convert the set of pre-selected features (or the latest values thereof) into a corresponding time calculation result among the aforementioned at least one time calculation result according to the set of pre-tuned parameters, for being input to the PTP timestamp generation circuit 112, and utilize the PTP timestamp generation circuit 112 to generate a corresponding timestamp among the aforementioned at least one timestamp based on this time calculation result, and more particularly, generate the corresponding timestamp in a corresponding packet among the aforementioned at least one packet, to allow the communication circuit 110 to send out the corresponding packet carrying the corresponding timestamp exactly at the time recorded by the corresponding timestamp, provided that the aforementioned FMPS and PPT have been properly performed. For brevity, similar descriptions for this embodiment are not repeated in detail here.

For better comprehension, the method may be illustrated with the working flow shown in FIG. 7, but the present invention is not limited thereto. According to some embodiments, one or more steps may be added, deleted, or changed in the working flow shown in FIG. 7. For example, at least one portion of operations in Step S10 and at least one portion of operations in Step S20 may be performed concurrently.

Based on the method, the apparatus 100 can, based on the set of pre-selected features (or the latest values thereof) during the packet processing within the communication circuit 110, utilize the ML circuit 120 to perform model computation with the aid of the pre-selected model 122 and the set of pre-tuned parameters (such as the pre-trained model and parameters), to accurately determine the timestamp (or the time recorded thereby) of the current packet, which can be a correct timestamp unaffected by any varying latency of the communication circuit 110. Additionally, the multiple predetermined features (such as the aforementioned circuit features) may comprise: the arbitration status of where the packet must pass (e.g., which channel or which MAC TX circuit 320 is currently granted access), the FIFO status (e.g., full or empty), whether the inter-packet gap (IPG) maintains the minimum spacing to achieve wire-speed, the MAC transmission speed, etc. Regarding the data generated during the DV regression simulation in the simulation level/phase 400SL, data is collected and analyzed to select the best/most valuable features and the most suitable model, and after training on a large amount of data, the optimal parameters are obtained. The method and the apparatus 100 of the present invention can accurately obtain the latency time of each packet, overcoming the problem of inaccurate timestamps caused by latency time variation during packet data transmission.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An apparatus for enhancing precision time protocol (PTP) timestamp precision using a machine learning (ML) circuit with aid of feature-and-model pre-selection (FMPS) and parameter pre-tuning (PPT), the apparatus comprising:
a communication circuit, configured to perform communication operations for an electronic device, wherein the communication circuit comprises:
a PTP timestamp generation circuit, positioned on a transmission path of the communication circuit, configured to generate at least one timestamp in at least one packet to allow the communication circuit to transmit the at least one packet carrying the at least one timestamp; and
the ML circuit, coupled to the communication circuit, configured to perform time calculation for the communication circuit, wherein the ML circuit comprises:
a pre-selected model running on the ML circuit, configured to obtain a set of pre-selected features from the communication circuit, and convert the set of pre-selected features into at least one time calculation result according to a set of pre-tuned parameters, to allow the PTP timestamp generation circuit to generate the at least one timestamp according to the at least one time calculation result.

2. The apparatus of claim 1, wherein the communication circuit and the ML circuit are installed in the electronic device to allow the electronic device to perform time synchronization in accordance with PTP.

3. The apparatus of claim 1, wherein the communication circuit comprises multiple sub-circuits positioned on the transmission path, and the PTP timestamp generation circuit is one of the multiple sub-circuits.

4. The apparatus of claim 3, wherein the multiple sub-circuits comprise multiple medium access control (MAC) layer sub-circuits; and the multiple MAC layer sub-circuits comprise a MAC security classifier circuit, a MAC security encryption circuit, and at least one MAC transmission circuit.

5. The apparatus of claim 1, wherein under control of the ML circuit, time indicated by the at least one timestamp and time at which the at least one packet is sent out from the electronic device correspond to each other, without being affected by any varying latency of the communication circuit.

6. The apparatus of claim 1, wherein the at least one time calculation result indicates a latency of time at which the at least one packet is sent out from the electronic device with respect to time at which the at least one timestamp is generated in the at least one packet.

7. The apparatus of claim 1, wherein the communication circuit and the ML circuit are integrated into an integrated circuit; and the set of pre-selected features, the pre-selected model, and the set of pre-tuned parameters are obtained in at least one previous phase before a manufacturing phase of the integrated circuit.

8. The apparatus of claim 7, wherein the at least one previous phase comprises at least one simulation phase; and a procedure for obtaining the set of pre-selected features, the pre-selected model, and the set of pre-tuned parameters comprises:
selecting a set of predetermined features among multiple predetermined features of the communication circuit as the set of pre-selected features;
selecting a predetermined model among multiple predetermined models as the pre-selected model; and
performing parameter tuning on the predetermined model to obtain multiple tuned parameters of the predetermined model as the set of pre-tuned parameters.

9. The apparatus of claim 8, wherein the procedure further comprises:
performing data collection regarding the multiple predetermined features to establish a database of the multiple predetermined models, for determining the set of pre-selected features.

10. A method for enhancing precision time protocol (PTP) timestamp precision using a machine learning (ML) circuit with aid of feature-and-model pre-selection (FMPS) and parameter pre-tuning (PPT), the method comprising:
utilizing a communication circuit to perform communication operations for an electronic device, wherein the communication circuit comprises a PTP timestamp generation circuit positioned on a transmission path of the communication circuit, and utilizing the communication circuit to perform the communication operations for the electronic device further comprises:
utilizing the PTP timestamp generation circuit to generate at least one timestamp in at least one packet to allow the communication circuit to transmit the at least one packet carrying the at least one timestamp; and
utilizing the ML circuit to perform time calculation for the communication circuit, wherein the ML circuit comprises a pre-selected model running on the ML circuit, and utilizing the ML circuit to perform the time calculation for the communication circuit further comprises:
utilizing the pre-selected model running on the ML circuit to obtain a set of pre-selected features from the communication circuit, and convert the set of pre-selected features into at least one time calculation result according to a set of pre-tuned parameters, to allow the PTP timestamp generation circuit to generate the at least one timestamp according to the at least one time calculation result.
